(19) United States
(12) Patent Application Publication
(10) Pub. No.: US 2017/0102547 A1
(43) Pub. Date: Apr. 13, 2017

(54) HEAD-MOUNTED DEVICE

(71) Applicant: Coretronic Corporation, Hsin-Chu (TW)

(72) Inventors: Chung-Ting Wei, Hsin-Chu (TW); Hsiang-Hua Wang, Hsin-Chu (TW)

(21) Appl. No.: 15/196,044

(22) Filed: Jun. 29, 2016

(30) Foreign Application Priority Data
Oct. 7, 2015 (TW) 104132925

(51) Int. Cl. G02B 27/01

(52) U.S. Cl. CPC G02B 27/0176; G02B 27/0172; G02B 2027/0159; G02B 2027/0198

(57) ABSTRACT

A head-mounted device including a main body, a projection device and a beam combiner is provided. The main body has an upper shade portion and a lower shade portion, wherein the upper shade portion and the lower shade portion have an opening defined therebetween. The projection device is disposed within the lower shade portion and adapted to generate a projection beam, and the projection beam is adapted to be transmitted from the lower shade portion to the opening. The beam combiner is connected to the upper shade portion and located in the opening, wherein the beam combiner is located at a transmission path of the projection beam to be adapted to reflect the projection beam into the main body.

### CROSS-REFERENCE TO RELATED APPLICATION

This application claims the priority benefit of Taiwan application serial no. 104132925, filed on Oct. 7, 2015. The entirety of the above-mentioned patent application is hereby incorporated by reference herein and made a part of this specification.

### BACKGROUND OF THE DISCLOSURE

1. Field of the Disclosure

The disclosure relates to a head-mounted device, and more particularly to a head-mounted device having a display device.

2. Description of Related Art

A head-mounted display is a kind of wearable device which uses an optical projection system to project an image or text information into users' eyes. In addition to applications in the military field, the head-mounted displays are also used in fields such as industrial production, simulation training, three-dimensional display, medical, sports, video games, and so on. In recent years, techniques of combination of conventional helmet and head-mounted displays are driven by the rise of heavy-duty motorcycle sports. In detailed, when the heavy-duty motorcycle is at high speed, if the rider takes his/her eyes off the road ahead in order to watch the dashboard of the heavy-duty motorcycle, it may result in highly dangerous of riding. Accordingly, a helmet having a display function may project the information of the dashboard in real-time into the rider's eyes, thereby the abovementioned dangerous riding problem may be resolved.

At the present, most of the helmets having display functions use the windshield visor of the helmet to reflect the projection beams to the rider's eyes. However, this design may result that the windshield visor has to be able to reduce wind resistance and also avoid aberrations. Therefore, the difficulty in manufacturing is increased, resulting that the product cost is increased, and the special design of the windshield visor based on wind resistance reduction may also be restricted and the stability may also be affected while driving at high speed. In addition, in some helmets having display functions, the projection system thereof is embedded in the upper shade portions of the helmets, and such configuration may reduce the thickness of the cushion layer in the upper portion, thereby reducing the protection ability against the rider's head. Besides, in some helmets having display functions, the projection beams are projected from the bottom directly up to the rider's eyes, and in such configuration, the user should gaze down to surely watch the information displayed by the projection beam, thus thereby at high speed still causing a great threat to traffic safety.

The information disclosed in this “Description of Related Art” section is only for enhancement understanding of the background of the invention and therefore it may contain information that does not form the prior art that is already known to a person of ordinary skill in the art. Furthermore, the information disclosed in this “Description of Related Art” section does not mean that one or more problems to be solved by one or more embodiments of the invention were acknowledged by a person of ordinary skill in the art.

### SUMMARY OF THE DISCLOSURE

The disclosure provides a head-mounted device, capable to save manufacturing costs and improve the convenience and safety of use.

Other objects and advantages of the invention can be further illustrated by the technical features broadly embodied and described as follows.

To achieve one, a part, or all of the objectives aforementioned or other objectives, one embodiment of the disclosure provides a head-mounted device including a main body, a projection device and a beam combiner. The main body includes an upper shade portion and a lower shade portion connected to each other, wherein the upper shade portion and the lower shade portion have an opening defined therebetween. The projection device is disposed within the lower shade portion and adapted to generate a projection beam, and the projection beam is adapted to be transmitted from the lower shade portion to the opening. The beam combiner is connected to the upper shade portion and located on a transmission path of the projection beam to be adapted to reflect the projection beam into the internal part of the main body.

In light of the above, the embodiment of the disclosure has at least one of the following advantages or effect. In the head-mounted device of the disclosure, the beam combiner which is additionally disposed is used for reflecting the projection beam into the user's eyes, instead of using the transparent cover of the head-mounted device to reflect the projection beam. Accordingly, in the case that the main body and the transparent cover of the head-mounted device respectively serve as the helmet and the windshield visor, the degree of difficulty of manufacturing is not increased by having to take the reflection effect of the windshield visor would not be taken into account, thereby the manufacturing cost is reduced, and there is no restriction in design of the windshield visor to have a special shape design based on reduction of wind resistance. In addition, the projection device is disposed within the lower shade portion, but not disposed within the upper shade portion, of the main body of the head-mounted device of the disclosure, thus the thickness of the cushion layer is not reduced due to the disposing of the projection device, such that the upper shade portion has a superior protection ability against the user's head. Furthermore, the beam combiner is connected to the upper shade portion and located in the opening of the main body of the head-mounted device of the disclosure, and the opening corresponds to the user's eyes, therefore the projection beam, which is transmitted in the direction from the lower shade portion to the upper shade portion, may be reflected by the beam combiner from the front of the user's eyes into the user's eyes, instead of directly projected into the user's eyes from the bottom. Thereby, no need to gaze down, the user can surely watch the information displayed by the head-mounted device, so as to improve the convenience and safety of use of the head-mounted device.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view illustrating a head-mounted device according to an exemplary embodiment of the disclosure.

FIG. 2 is a schematic view illustrating a status of the rider of FIG. 1 riding a motorcycle.

FIG. 3 is a block diagram illustrating some components of the head-mounted device of FIG. 1.

FIG. 4 is a schematic view illustrating a head-mounted device according to another exemplary embodiment of the disclosure.

FIG. 5 is a schematic view illustrating the rotation of the reflective member and the beam combiner of FIG. 4.

FIG. 6 is a block diagram illustrating some components of the head-mounted device of FIG. 4.

FIG. 7 is a block diagram illustrating some components of the head-mounted device of another exemplary embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

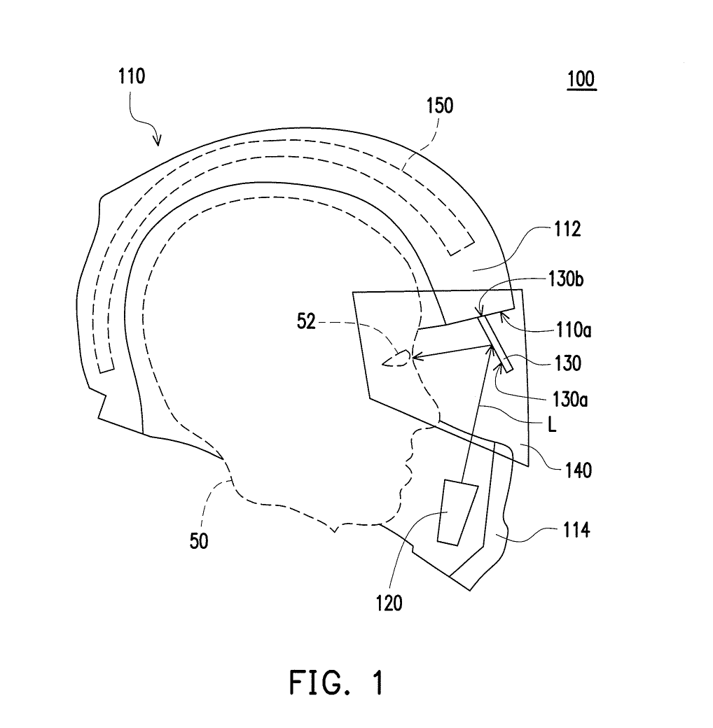

FIG. 1 is a schematic view illustrating a head-mounted device according to an exemplary embodiment of the disclosure. Referring to FIG. 1, the head-mounted device 100 of the embodiment includes a main body 110, a projection device 120, a beam combiner 130 and a transparent cover 140. The main body 110 is a helmet or other head-mounted devices which protect against the head of the motorcycle rider. The main body 110 of FIG. 1 is a helmet for example, wherein the main body 110 includes an upper shade portion 112 and a lower shade portion 114 connected to each other. The upper shade portion 112 and the lower shade portion 114 have an opening 110a defined therebetween. The main body 110 of the head-mounted device 100 is covered a head of a user 50 and configured to protect the head. The location of the opening 110a corresponds to the eyes 52 of the user 50, so that the user 50 may see the road ahead or the environment through the opening 110a of the main body 110. The transparent cover 140 is a windshield visor of a helmet for example, pivoted to the main body 110 and adapted to entirely cover the opening 110a. The pivoting method of the transparent cover 140 may be similar to the disposing way of the windshield of a conventional helmet, and the details are not described herein.

The projection device 120 is disposed within the lower shade portion 114 of the main body 110 and adapted to generate a projection beam L. The projection beam L is adapted to be transmitted to the opening 110a in a direction from lower shade portion 114 toward the upper shade portion 112, and the projection beam L includes an image or text information. The beam combiner 130 is connected to the upper shade portion 112 and located in the opening 110a, wherein the beam combiner 130 is located on the transmission path of the projection beam L and has a reflective surface 130a. The reflective surface 130a is a plane for example, and adapted to reflect the projection beam L to the internal part of the main body 110 via the opening 110a, then to the eyes 52 of the user 50, as such, via the beam combiner 130, the user 50 may see the image or text information of the virtual image (not shown in the drawings) formed by the projection beam L. In the embodiment, a side of the beam combiner 130 is pivotally connected to the edge of the upper shade portion 112, and the beam combiner 130 may be designed to correspond to a single eye or both eyes of the user 50. The beam combiner 130 may be a partially transmissive and partially reflective optical element, for example, a combiner, wherein via the beam combiner 130, the user may see the image or text information of the virtual image which is overlapped with the condition of road ahead.

In the abovementioned configuration, the beam combiner 130 which is additionally disposed is used for reflecting the projection beam L into the eyes of the user 50, instead of using the transparent cover 140 (i.e., the so-called windshield visor) of the head-mounted device 100 to reflect the projection beam. Accordingly, the degree of difficulty of manufacturing is not increased, because it is unnecessary to consider the reflection effect of the windshield visor. Therefore, the manufacturing cost may be saved, and there is no restriction in design of the windshield visor to have a special shape design based on reduction of wind resistance.

In the embodiment, the head-mounted device 100 further includes a cushion layer 150, wherein the cushion layer 150 is disposed within the upper shade portion 112 of the main body 110 and provides a cushion effect when the upper shade portion 112 is subjected to an impact, so as to protect against the head of the user 50. In the embodiment, the upper shade portion 112 of the main body 110 corresponds to a portion, from the forehead to the rear of the head of the user 50, and the lower shade portion 114 corresponds to a portion from the mouth to the chin of the user 50, for example, thus both the upper shade portion 112 and the lower shade portion 114 of the head-mounted device 100 provide protection to the entire head portion of the user 50. In addition, since the projection device 120 of the embodiment is disposed within the lower shade portion 114, but not disposed within the upper shade portion 112, of the main body 110 of the head-mounted device 100, thus the thickness of the cushion layer 150 in the upper shade portion 112 is not reduced due to the arrangement of the projection device 120. Compared to the conventional helmet in which the projection system is embedded in the upper shade portion of the helmet, the cushion layer 150 in the upper shade portion 112 of the head-mounted device 100 of the disclosure has a sufficient thickness to provide better protection ability against the head portion of the user 50.

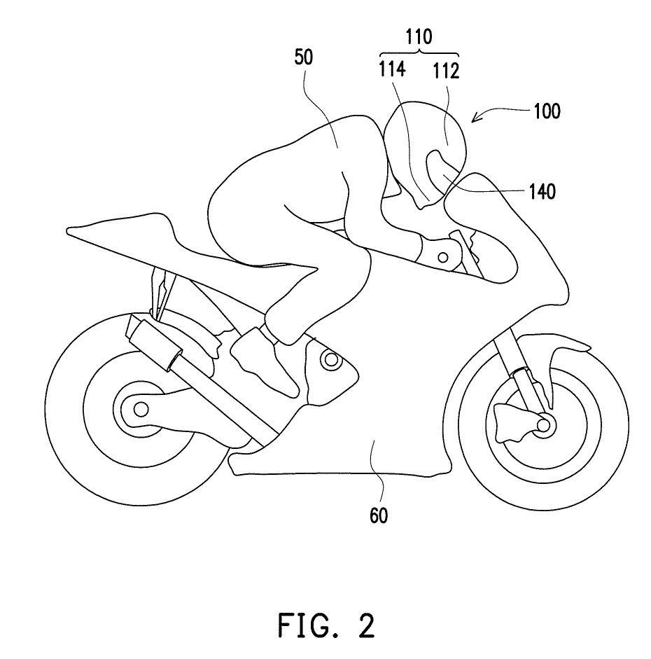

FIG. 2 is a schematic view illustrating a status of the rider of FIG. 1 riding a motorcycle. When the user 50 is riding on a heavy-duty motorcycle 60 as shown in FIG. 2 and leans forward, the line of sight of the user 50 is toward the upper portion of the opening 110a of the head-mounted device 100 shown in FIG. 1. The upper portion of the opening 110a is close to the edge of the upper shade portion 112 of the main body 110. Namely the user 50 may see the environment or status of the road ahead through a portion of the transparent cover 140 which corresponds to the upper portion of the opening 110a as the transparent cover 140 entirely covers the opening 110a. As such, since the beam combiner 130 is connected to the upper shade portion 112 and located in the opening 110a of the main body 110 of the head-mounted device 100, and the beam combiner 130 is located on the upper portion of the opening 110a and corresponds to the eyes 52 of the user 50, therefore the projection beam L, which is transmitted in the direction from the lower shade portion 114 to the upper shade portion 112, may be reflected by the beam combiner 130 from the front of the eyes 52 of the user 50 into the user's eyes 52, instead of directly projected into the user's eyes 52 from the bottom of the helmet. Thereby, no need to gaze down, the user 50 may surely watch the information displayed by the head-mounted device 100, so as to improve the convenience and safety of use of the head-mounted device 100 when the user 50 is riding. Since the transparent cover 140 is light transmittable, no matter that the transparent cover 140 covers or does not cover the opening 110a, it may not affect the user 50 to watch the image or text information which is overlapped with the status of road ahead, via the projection beam L reflected by the beam combiner 130. Moreover, as the transparent cover 140 covers the opening 110a, the beam combiner 130 is located between the transparent cover 140 and the eyes 52 of the user 50.

Referring to FIG. 1, in the embodiment, the beam combiner 130 is pivoted to the upper shade portion 112 via the side 130b for example, and adapted to rotate relative to the upper shade portion 112 inwardly or outwardly at the opening 110a by using its side 130b as a rotating shaft, such that the user 50 may adjust the angle of the beam combiner 130 as required, and the projection beam L may be accurately reflected into the eyes 52 of the user 50 by adjusting the beam combiner 130.

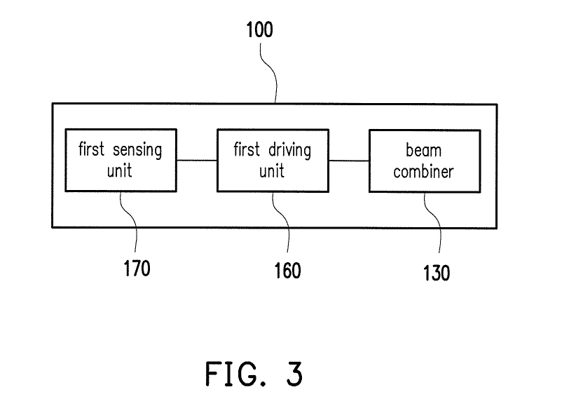

FIG. 3 is a block diagram illustrating some components of the head-mounted device of FIG. 1. Referring to FIG. 3, the head-mounted device 100 further includes a first driving unit 160, wherein the first driving unit 160 is a motor, for example, and disposed within the upper shade portion 112 of the main body 110 as shown in FIG. 1, and The first driving unit 160 is connected with the beam combiner 130 for driving the beam combiner 130 to rotate relative to the upper shade portion 112.

In addition, the head-mounted device 100 of the embodiment as shown in FIG. 3 further includes a first sensing unit 170, wherein the first sensing unit 170 is a gravity sensor (G sensor), for example, or other suitable kinds of dynamic sensing elements, disposed in the main body 110 as shown in FIG. 1 and adapted to detect an inclined angle of the main body 110, wherein the first sensing unit 170, for example, detects the inclined angle of the main body 110 relative to the gravity direction (not shown in the drawings) or the inclined angle relative to the horizontal direction (not shown in the drawings). The first driving unit 160 is electrically connected to the first sensing unit 170 and drives the beam combiner 130 to rotate within the opening 110a according to the inclined angle measured by the first sending unit 170. Accordingly, the beam combiner 130 may automatically rotate to a plurality of predetermined positions corresponding to various inclined angles of the user's 50 head portion and the head-mounted device 100 thereon, such that the projection beam L may be successfully reflected toward the eyes 52 of the user 50 by the beam combiner 130, when the user 50 changes the riding positions or stops riding the motorcycle. In other embodiments, other suitable methods may also used for driving the beam combiner 130 to rotate, and the disclosure is not limited thereto.

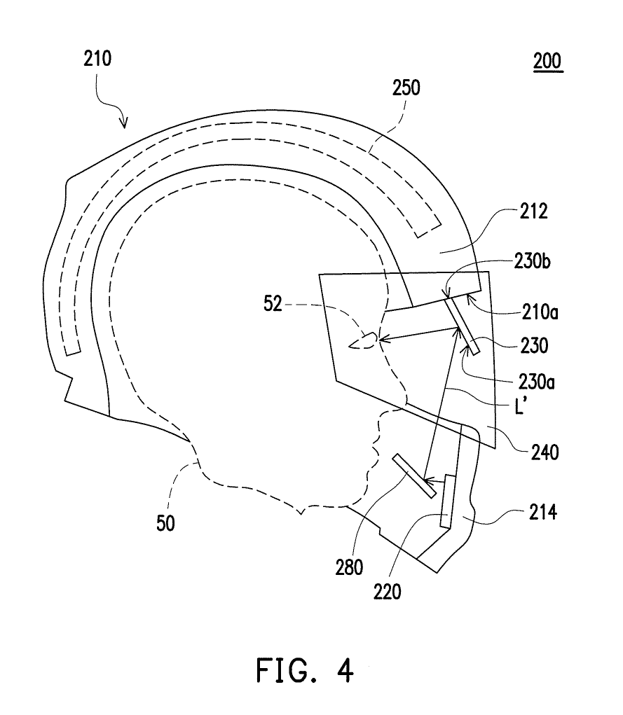

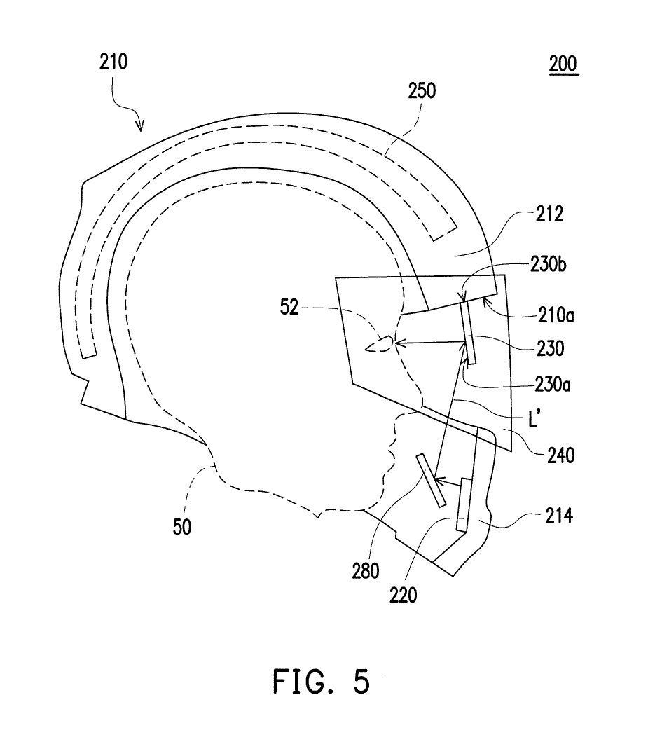

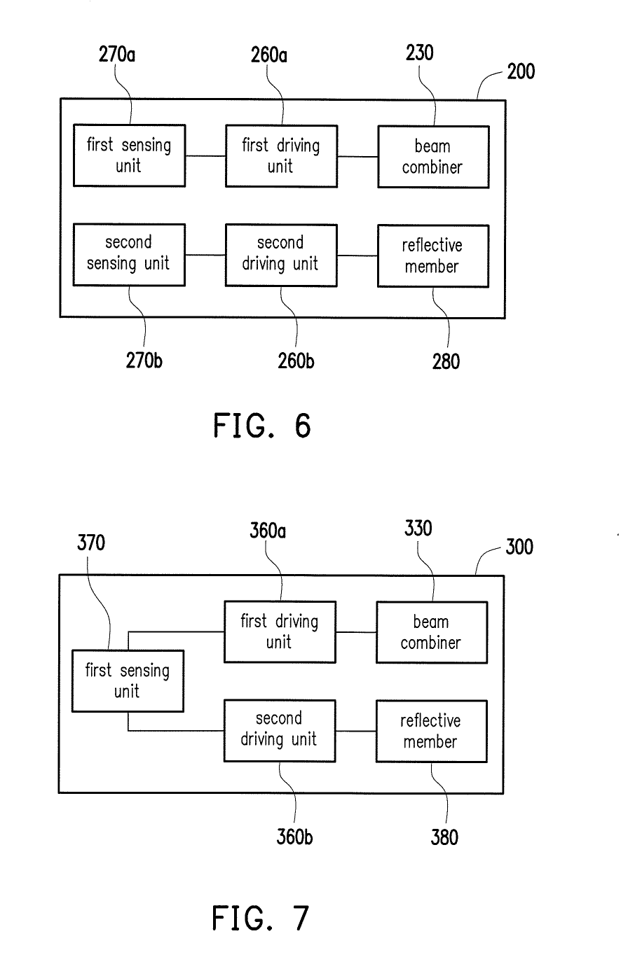

FIG. 4 is a schematic view illustrating a head-mounted device according to another exemplary embodiment of the disclosure. FIG. 5 is a schematic view illustrating the rotation of the reflective member and the beam combiner of FIG. 4. FIG. 6 is a block diagram illustrating some components of the head-mounted device of FIG. 4. In the head-mounted device 200 shown in FIG. 4 through FIG. 6, the arrangement of the main body 210, the upper shade portion 212, the lower shade portion 214, the beam combiner 230, the reflective surface 230a, the side 230b of the beam combiner 230, the transparent cover 240, the cushion layer 250, the first driving unit 260a and the first sensing unit 270a is similar to the arrangement of the main body 110, the upper shade portion 112, the lower shade portion 114, the beam combiner 130, the reflective surface 130a, the side 130b of the beam combiner 130, the transparent cover 140, the cushion layer 150, the first driving unit 160 and the first sensing unit 170 of FIG. 1 through FIG. 3, and it is not repeated herein.

The difference between the head-mounted device 200 and the head-mounted device 100 is that the head-mounted device 200 further includes a reflective member 280. The reflective member 280 is disposed within the lower shade portion 214 of the main body 210 and located on the transmission path of the projection beam L′. The reflective member 280 is adapted to reflect the projection beam U which is transmitted from the projection device 220 disposed within the lower shade portion 214 and directs it to the beam combiner 230 in a direction toward the upper shade portion 212. In the embodiment, the reflective member 280 is pivotally connected to the lower shade portion 214 and adapted to rotate relative to the projection device 220 which is located within the lower shade portion 214, so as to accurately guide the projection beam L′ to the eyes 52 of the user 50 in response to the location of the beam combiner 230. Therefore, the reflective element 280 and the beam combiner 230 are cooperated with each other to be adjusted for directing the projection beam L′ toward the eyes 52 of the user 50.

Specifically, as shown in FIG. 6, the head-mounted device 200 of the embodiment further includes a second driving unit 260b and a second sensing unit 270b electrically connected to each other. The second driving unit 260b is, for example, a motor and disposed within the main body 210 as shown in FIG. 4 and FIG. 5 and the second driving unit 260b is connected with the reflective element 280, so as to drive the reflective member 280 to rotate relative to the projection device 220. The second sensing unit 270b is, for example, a gravity sensor (G sensor) or other suitable kinds of dynamic sensing elements, disposed within the main body 210 as shown in FIG. 4 and FIG. 5 and adapted to detect the inclined angle of the main body 210. The second driving unit 260b drives the reflective member 280 to rotate relative to the projection device 220 according to the inclined angle measured by the second sensing unit 270b. Accordingly, the beam combiner 230 and the reflective member 280 may be automatically adjusted and relatively rotated into a plurality of predetermined positions (FIG. 4 and FIG. 5 respectively show the beam combiner 230 and the reflective member 280 rotate into different predetermined positions) corresponding to various inclined angles of the user's 50 head portion and the head-mounted device 200 thereon, such that the projection beam L′ is successfully reflected toward the eyes 52 of the user 50 by the reflective element 280 and the beam combiner 230, when the user 50 changes the riding positions or stops riding the motorcycle. In other embodiments, other suitable methods may also used for driving the beam combiner 230 and the reflective member 280 to rotate, and the disclosure is not limited thereto.

FIG. 7 is a block diagram illustrating some components of the head-mounted device of another exemplary embodiment of the disclosure. In the head-mounted device 300 shown in FIG. 7, the arrangement of the beam combiner 330, the first driving unit 360a, the second driving unit 370b and the reflective member 380 is similar to the arrangement of the beam combiner 230, the first driving unit 260a, the second driving unit 260b and the reflective member 280 shown in FIG. 4 through FIG. 6, and it is not repeated herein.

The difference between the head-mounted device 300 and the head-mounted device 200 is that the head-mounted device 300 does not have the second sensing unit 270b shown in FIG. 6, and both the first driving unit 360a and the second driving unit 360b are electrically connected to the first sensing unit 370. In the head-mounted device 300, in addition that the first driving unit 360a drives the beam combiner 330 to rotate according to the inclined angle measured by the first sensing unit 370, the second driving unit 360b also drives the reflective member 380 to rotate relative to the projection device according to the inclined angle measured by the first sensing unit 370, so that the reflective member 380 reflects the projection beam emitted from the projection device to the beam combiner 330. Namely, the head-mounted device 300 of the embodiment uses a single sensing unit (the first sensing unit 370) to make the reflective member 380 able to rotate in response to the rotation angle of the beam combiner 330.

In light of the foregoing, the embodiments of the disclosure have at least one of the following advantages or effect. In the head-mounted device of the disclosure, the beam combiner which is additionally disposed is used for reflecting the projection beam into the user's eyes, instead of using the transparent cover of the head-mounted device to reflect the projection beam. Accordingly, in the case that the main body and the transparent cover of the head-mounted device respectively serve as the helmet and the windshield, the degree of difficulty of manufacturing is not increased by having to take the reflection effect of the windshield visor would not be taken into account, thereby the manufacturing cost is reduced, and there is no restriction in design of the windshield visor to have a special shape design based on reduction of wind resistance. In addition, the projection device is disposed within the lower shade portion, but not disposed within the upper shade portion, of the main body of the head-mounted device of the disclosure, thus the thickness of the cushion layer is not reduced due to the arrangement of the projection device, such that the upper shade portion has a superior protection ability against the user's head. Furthermore, the beam combiner is pivotally connected to the upper shade portion and located in the opening of the main body of the head-mounted device of the disclosure, and the opening corresponds to the user's eyes, therefore the projection beam, which is transmitted in the direction from the lower shade portion to the upper shade portion, may be reflected by the beam combiner from the front of the user's eyes into the user's eyes, instead of directly projected into the user's eyes from the bottom. Thereby, no need to gaze down, the user can surely watch the information displayed by the head-mounted device, so as to improve the convenience and safety of use of the head-mounted device.

The foregoing description of the preferred embodiments of the invention has been for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A head-mounted device, comprising:
a main body, comprising an upper shade portion and a lower shade portion connected to each other, wherein the upper shade portion and the lower shade portion have an opening defined therebetween;
a projection device, disposed within the lower shade portion and adapted to generate a projection beam, wherein the projection beam is adapted to be transmitted from the lower shade portion to the opening; and
a beam combiner, connected to the upper shade portion and located in the opening, wherein the beam combiner is located on a transmission path of the projection beam, so as to be adapted to reflect the projection beam into the main body.

2. The head-mounted device as claimed in claim 1, wherein the beam combiner is pivoted to the upper shade portion and adapted to rotate in the opening relative to the upper shade portion.

3. The head-mounted device as claimed in claim 2, further comprising a first driving unit, and the first driving unit is disposed within the upper shade body of the main body and adapted to drive the beam combiner to rotate.

4. The head-mounted device as claimed in claim 3, further comprising a first sensing unit, the first sensing unit is electrically connected to the first driving unit, wherein the first sensing unit is disposed on the main body and adapted to detect an inclined angle of the main body, and the first driving unit is adapted to drive the beam combiner to rotate in the opening according to the inclined angle.

5. The head-mounted device as claimed in claim 1, further comprising a reflective member disposed within the lower shade portion, wherein the reflective member is located on the transmission path of the projection beam and adapted to reflect the projection beam transmitted from the projection device to the beam combiner.

6. The head-mounted device as claimed in claim 5, wherein the reflective member is pivoted to the lower shade portion and adapted to rotate relative to the projection device within the lower shade portion.

7. The head-mounted device as claimed in claim 6, further comprising a second driving unit, wherein the second driving unit is disposed within the main body and adapted to drive the reflective member to rotate.

8. The head-mounted device as claimed in claim 7, further comprising a second sensing unit, the second sensing unit is electrically connected to the second driving unit, wherein the second sensing unit is disposed within the main body and adapted to detect an inclined angle of the main body, and the second driving unit is adapted to drive the reflective member to rotate relative to the projection device according to the inclined angle.

9. The head-mounted device as claimed in claim 4, further comprising a reflective member and a second driving unit, wherein the reflective member and the second driving unit are disposed within the lower shade portion and the second driving unit is electrically connected to the first sensing unit, wherein the reflective member is located on the transmission path of the projection beam, the second driving unit is adapted to drive the reflective member to rotate relative to the projection device according to the inclined angle measured by the first sensing unit, so that the reflective member reflects the projection beam transmitted from the projection device to the beam combiner.

10. The head-mounted device as claimed in claim 1, wherein a reflective surface of the beam combiner is adapted to reflect the projection beam, and the reflective surface is a plane.

11. The head-mounted device as claimed in claim 1, wherein the beam combiner is a partially transmissive and partially reflective optical element.

12. The head-mounted device as claimed in claim 1, further comprising a transparent cover, wherein the transparent cover is pivotally connected to the main body and adapted to cover the opening.

13. The head-mounted device as claimed in claim 1, wherein the main body is a helmet.

14. The head-mounted device as claimed in claim 1, further comprising a cushion layer, wherein the cushion layer is disposed within the upper shade portion.
